(19) United States
(12) Patent Application Publication
(10) Pub. No.: US 2022/0405500 A1
(43) Pub. Date: Dec. 22, 2022

(54) COMPUTATIONALLY EFFICIENT AND ROBUST EAR SADDLE POINT DETECTION

(71) Applicant: Google LLC, Mountain View, CA (US)

(72) Inventors: Mayank Bhargava, Kitchener (CA); Idris Syed Aleem, Kitchener (CA); Yinda Zhang, Daly City, CA (US); Sushant Umesh Kulkarni, Waterloo (CA); Rees Anwyl Simmons, Waterloo (CA); Ahmed Gawish, Waterloo (CA)

(21) Appl. No.: 17/304,419

(22) Filed: Jun. 21, 2021

(51) Int. Cl. G06K 9/00; G06T 7/73; G06K 9/32; G06K 9/62; G06T 17/00; G06T 7/50; G06T 19/20; G06T 7/246; G02C 7/02

(52) U.S. Cl. CPC G06K 9/00248; G06T 7/73; G06K 9/3241; G06K 9/6217; G06T 17/00; G06T 7/50; G06T 19/20; G06K 9/00281; G06T 7/246; G02C 7/027; G06T 2207/30201; G06T 2219/2004; G06T 2207/20084

(57) ABSTRACT

A computer-implemented method includes receiving a two-dimensional (2-D) side view face image of a person, identifying a bounded portion or area of the 2-D side view face image of the person as an ear region-of-interest (ROI) area showing at least a portion of an ear of the person, and processing the identified ear ROI area of the 2-D side view face image, pixel-by-pixel, through a trained fully convolutional neural network model (FCNN model) to predict a 2-D ear saddle point (ESP) location for the ear shown in the ear ROI area. The FCNN model has an image segmentation architecture.

### TECHNICAL FIELD

This description relates to image processing in a context of sizing of glasses for a person, and in particular in the context of remotely fitting the glasses to the person.

### BACKGROUND

Eyewear (e.g., glasses, also known as eyeglasses or spectacles, smart glasses, wearable heads-up displays (WHUDs), etc.) are vision aids. The eyewear can consist of glass or hard plastic lenses mounted in a frame that holds them in front of a person's eyes, typically utilizing a nose bridge over the nose, and legs (known as temples or temple pieces) which rest over the ears of the person. Human ears are highly variable structures with different morphological and individualistic features in different individuals. The resting positions of the temple pieces over the ears of the person can be at vertical heights above or below the heights the customer's eye pupils (in their natural head position and gaze). The resting positions of the temple pieces over the ears (e.g., on ear apex or ear saddle points (ESPs))) of the person can define the tilt and width of the glasses and determine both the display and comfort.

Virtual try-on (VTO) technology can let users try on different pairs of glasses, for example, on a virtual mirror on a computer, before deciding which glasses look or feel right. A VTO system may display virtual pairs of glasses positioned on the user's face in images that the user can inspect as she turns or tilts her head from side to side.

### SUMMARY

In a general aspect, an image processing system includes a processor, a memory, and a trained fully convolutional neural network (FCNN) model. The FCNN model is trained to process, pixel-by-pixel, an ear region-of-interest (ROI) area of a two-dimensional (2-D) side view face image of a person to predict a 2-D ear saddle point (ESP) location on the 2-D side view face image. The ear ROI area in the image shows or displays at least a portion of the person's ear. The processor is configured to execute instructions stored in memory to receive the 2-D side view face image of the person, and process the ear ROI area of the 2-D side view face image, pixel-by-pixel, through the FCNN model to locate the 2-D ESP.

In a general aspect, a system for virtually fitting glasses to a person includes a processor, a memory, and a three-dimensional (3-D) head model including representations of a person's ears. The processor is configured to executed instructions stored in the memory to receive two-dimensional (2-D) co-ordinates of a predicted 2-D ear saddle point for an ear represented in the 3-D head model, attach the predicted 2-D ear saddle point to a lobe of the ear, and project the predicted 2-D ear saddle point through 3-D space to a 3-D ESP point located at a depth on a side the ear.

In a further aspect, the processor is further configured to execute instructions stored in memory to conduct a depth search in a predefined cuboid region of the 3-D head model to determine the depth for locating the projected 3-D ESP point at the depth to the side of the person's ear, and generate virtual glasses to fit the 3-D head model with a temple piece of the glasses resting on the projected 3-D ESP point.

In a general aspect, a computer-implemented method includes receiving a two-dimensional (2-D) side view face image of a person, identifying a bounded portion or area of the 2-D side view face image of the person as an ear region-of-interest (ROI) area showing at least a portion of an ear of the person, and processing the identified ear ROI area of the 2-D side view face image, pixel-by-pixel, through a trained fully convolutional neural network model (FCNN model) to predict a 2-D ear saddle point (ESP) location for the ear shown in the ear ROI area. The FCNN model has an image segmentation architecture.

In a general aspect, a computer-implemented method includes receiving two-dimensional (2-D) face images of a person. The 2-D face images include a plurality of image frames showing different perspective views of the person's face. The method further includes processing at least some of the plurality of image frames through a face recognition tool to determine 2-D ear saddle point (ESP) locations for a left ear and a right ear shown in the image frames, and identifying a 2-D ESP location determined to be a correct ESP location with a confidence value greater than a threshold confidence value as being a robust ESP for each of the left ear and the right ear. The method further includes using the robust ESP for the left ear and the robust ESP for the right ear as key points for tracking movements of the person's face in a virtual try-on session displaying different image frames with a trial pair of glasses positioned on the person's face.

### BRIEF DESCRIPTION OF THE DRAWINGS

FIG. 1 is a block diagram illustrating an example image processing system, for locating ear saddle points (ESPs) on two-dimensional (2-D) face images, in accordance with the principles of the present disclosure.

FIGS. 2A, 2B and 2C illustrate example face images of different perspective views with eye pupils and facial landmark points marked on the images, in accordance with the principles of the present disclosure.

FIG. 3 illustrates examples of ear region-of interest (ROI) areas defined around the ears and extracted from side view face images using a single landmark point marked on each ear in the corresponding front view face image, in accordance with the principles of the present disclosure.

FIG. 4A illustrates three example ear ROI area images that can be used as training data for a U-Net model, in accordance with the principles of the present disclosure.

FIG. 4B schematically illustrates ground truth (GT) confidence maps for GT ESP locations for the three example ear ROI area images of FIG. 4A, in accordance with the principles of the present disclosure.

FIG. 4C schematically illustrates ESP confidence maps for ESP locations predicted by a U-Net model for the three example ear ROI area images of FIG. 4A, in accordance with the principles of the present disclosure.

FIG. 5 schematically illustrates an example side view face image processed by the system of FIG. 1 to identify a two-dimensional ESP on a side of a person's right ear, in accordance with the principles of the present disclosure.

FIG. 6A schematically illustrates a portion of a three-dimensional (3-D) head model of a person with an original predicted 2-D ESP processed by the system of FIG. 1 snapped on an outer lobe of the person's ear, in accordance with the principles of the present disclosure.

FIG. 6B schematically illustrates cuboid regions (i.e., convex polyhedrons) of the 3-D head model of FIG. 6A that may be searched to find a depth point for locating a projected 3-D ESP point at a depth z behind a person's ear, in accordance with the principles of the present disclosure.

FIG. 6C schematically illustrates a portion of the 3-D head model of FIG. 6A with the original predicted 2-D ESP snapped on the outer lobe of the person's ear, and the projected 3-D ESP point disposed at a depth z behind the person's ear, in accordance with the principles of the present disclosure.

FIG. 6D illustrates another view of the 3-D head model of FIG. 6A with the projected 3-D ESP point disposed at a depth behind, and to a side of, the person's ear, in accordance with the principles of the present disclosure.

FIG. 6E illustrates the example 3-D head model of FIG. 6A fitted with a pair of virtual glasses having a temple piece (e.g., temple piece 92) passing through or attached to the projected 3-D ESP point in 3-D space, in accordance with the principles of the present disclosure.

FIG. 7 illustrates an example method for determining 2-D locations of ear saddle points (ESP) of a person from 2-D images of the person's face, in accordance with the principles of the present disclosure.

FIG. 8 illustrates an example method for determining and using 2-D locations of ear saddle points (ESPs) as robust ESPs/key points in a virtual try-on session, in accordance with the principles of the present disclosure.

FIG. 9 illustrates an example of a computing device and a mobile computing device, which may be used with the techniques described herein.

It should be noted that the drawings are intended to illustrate the general characteristics of methods, structure, or materials utilized in certain example implementations and to supplement the written description provided below. The drawings, however, need not be to scale and may not precisely reflect the precise structural or performance characteristics of any given implementation, and should not be interpreted as defining or limiting the range of values or properties encompassed by example implementations. The use of similar or identical reference numbers in the various drawings is intended to indicate the presence of a similar or identical element or feature in the various drawings.

### DETAILED DESCRIPTION

Ear saddle points (ESPs) are anatomical features on which temple pieces of head-worn eyewear (e.g., glasses) rest behind the ears of a person. The glasses may be of any type, including, for example, ordinary prescription or non-prescription glasses, sun glasses, smart glasses, augmented reality (AR) glasses, virtual reality (VR) glasses, and wearable heads-up displays (WHUDs), etc. Proper sizing of the eyewear (e.g., glasses) to fit a person's head requires consideration of the precise positions or locations of the ESPs in three-dimensional (3-D) space.

In physical settings (e.g., in an optometrist's office), glasses (including the temple pieces) may be custom adjusted to fit a particular person based on, for example, direct three-dimensional (3-D) anthropometric measurements of features of the person's head (e.g., eyes, nose, and ears).

In virtual settings, where the person is remote (e.g., on-line, or on the Internet), a virtual 3-D prototype of the glasses may be constructed after inferring the 3-D features of the person's head from a set of two-dimensional (2-D) images of the person's head. The glasses may be custom fitted by positioning the virtual 3-D prototype on a 3-D head model of the person in a virtual-try-on (VTO) session (simulating an actual physical fitting of the glasses on the person's head). Proper sizing and accurate virtual-try-on (VTO) are important factors for successfully making custom fitted glasses for remote consumers.

In some virtual fitting situations, the ESPs of a remote person can be identified and located on the 2-D images using a sizing application (app) to process 2-D images (e.g., digital photographs or pictures) of the person's head. The sizing app may involve a machine learning model (e.g., a trained neural network model) to process the 2-D images to identify or locate the ESPs. To run such a sizing app, for example, on a mobile phone, to efficiently identify or locate the ESP of the person based on a 2-D image, the processes or algorithms used in the sizing app to process the 2-D images should be fast, and consume little memory and other computational resources.

Previous efforts at using sizing apps (e.g., on mobile phones) to locate the ESPs in the 2-D images have been inefficient and have yielded less than satisfactory results. The previous sizing apps have utilized two detection models (a first model and a second model) to locate the ESPs in the 2-D images. The first model localizes (crops) a portion or area (i.e., an “ear region-of-interest (ROI)”) in a 2-D face image to isolate an ear image for further analysis. For convenience in description, the terms “ear ROI,” “ear ROI area,” and “ear ROI area image” may be used interchangeably hereinafter. An ESP identified by two dimensional co-ordinates (e.g., (x, y)) may be referred to as a 2-D ESP point, while an ESP identified by three dimensional co-ordinates (e.g., (x, y, z)) may be referred to as a 3-D ESP point.

In the previous efforts, the second model defines and classifies large windows or coarse patches (e.g., 30 pixels by 30 pixels or greater, based on typical mobile phone image resolutions) in the cropped ear ROI areas (extracted using the first model) as being the ESPs. Further, the previous sizing apps have a large memory requirement (e.g., ˜30 MB to ˜100 MB), which can be a burdensome requirement on a mobile phone. Further, the cropped ear ROI areas are often imprecisely determined (geometrically) by the first model, or include covered up, unclear, or otherwise less than well-defined images of a full ear. Further, the second model in the sizing apps of the previous efforts merely gives low confidence outputs as the (coarse) ESPs on the imprecisely or improperly cropped ear ROI areas.

Efficient image processing systems and methods (collectively “solutions”) for locating ESPs on 2-D images of a person are described herein. The disclosed image processing solutions utilize neural network models and machine learning, are computationally efficient, and can be readily implemented on contemporary mobile phones to locate, for example, pixel-size 2-D ESPs on 2-D images of the person.

The disclosed image processing solutions involve receiving 2-D images (pictures) of the person's head in different orientations, identifying fiducial facial landmark features (landmark points) on the person's face in the 2-D images, and using at least one of the fiducial landmark points as a geometrical reference point or marker to define an area or portion (i.e., an ear region-of-interest (ROI)) in a side view face image of the person for ESP analysis and detection. The defined ear ROI may be a small portion of the side view face image, and may show or include at least a portion of an ear (left ear or right ear) of the person. For a side view face image having a typical size of ˜1000×1000 pixels, the defined ear ROI area may, for example, be less than ˜200×200 pixels. For reference, an average human ear is about 2.5 inches (6.3 centimeters) long. However, there can be large variations in ear shape, size and orientation from individual to individual and even between the left ears and right ears of individuals.

A trained neural network model analyzes the ear ROI area, pixel-by-pixel, to predict a pixel-sized 2-D location (or a few pixels-sized location) of the ESP in the ear ROI area of the 2-D side view face image. The model takes as input the ear ROI area image, predicts a probability (i.e., a probability value between 0% and 100% or equivalently a confidence value between 0 and 1) that each pixel is the actual or correct ESP, and outputs a confidence map of the predicted ESP locations. The output confidence map may have the same pixel resolution as the input ear ROI area image. Pixels with high confidence values in the confidence map are designated or deemed to be the actual or correct ESP.

The disclosed image processing solutions can be used to determine an ESP of a person, for example, for fitting glasses on the person. The fitting of glasses (e.g. sizing of the glasses) may be conducted in a virtual-try-on (VTO) system, in which the fitting is accomplished remotely (e.g., over the Internet) on a 3-D head model of the person. For proper fitting, the 2-D location of the ESP on the 2-D image is projected to a 3-D point at a depth on a side of the ear on the 3-D head model. The projected point may represent a 3-D ESP in 3-D space for fitting glasses on the person.

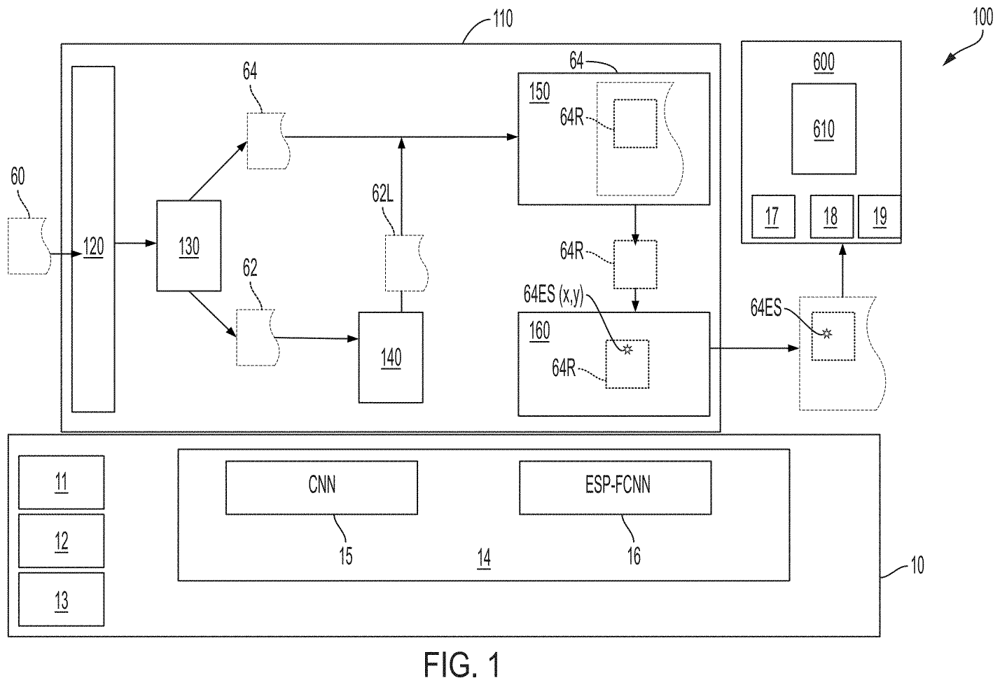

FIG. 1 is a block diagram illustrating an example image processing system, for locating ear saddle points (ESPs) on two-dimensional (2-D) face images, in accordance with the principles of the present disclosure.

System 100 may include an image processing pipeline 110 to analyze 2-D images. Image processing pipeline 110 may be hosted on, or run on, a computer system configured to process the 2-D images.

The computer system may include one or more standalone or networked computers (e.g., computing device 10). An example computing device 10 may, for example, include an operating system (e.g., O/S 11), one or more processors (e.g., CPU 12), one or more memories or data stores (e.g., memory 13), etc.

Computing device 10 may, for example, be a server, a desktop computer, a notebook computer, a netbook computer, a tablet computer, a smartphone, or another mobile computing device, etc. Computing device 10 may be a physical machine or a virtual machine. While computing device 10 is shown in FIG. 1 as a standalone device, it will be understood that computing device 10 may be a single machine, or a plurality of networked machines (e.g., machines in public or private clouds).

Computing device 10 may host a sizing application (e.g., application 14) configured to process images, for example, through an image processing pipeline 110. In example implementations, application 14 may include, or be coupled to, one or more convolutional neural network (CNN) models (e.g., CNN 15, ESP-FCNN 16, etc.). Application 14 may process an image through the one or more CNN models (e.g., CNN 15, ESP-FCNN 16, etc.) as the image is moved through image processing pipeline 110. At least one of the CNN models may be a fully convolutional neural network (FCNN) model (e.g., ESP-FCNN 16). A processor (e.g., CPU 12) in computing device 10 may be configured to execute instructions stored in the one or more memories or data stores (e.g., memory 13) to process the images through the image processing pipeline 110 according to program code in application 14.

Image processing pipeline 110 may include an input stage 120, a pose estimator stage 130, a fiducial landmarks detection stage 140, an ear ROI extraction stage 150, and an ESP identification stage 160. Processing images through the various stages 120-150 may involve processing the images through the one or more CNN and FCNN models (e.g., CNN 15, ESP-FCNN 16, etc.).

Input stage 120 may be configured to receive 2-D images of a person's head. The 2-D images may be captured using, for example, a smartphone camera. The received 2-D images (e.g., image 60) may include images (e.g., front and side view face images) taken at different orientations (e.g., neck rotations or tilt) of the person's head. The received 2-D images (e.g., image 60) may be processed through a pose estimator stage (e.g., pose estimator stage 130) and segregated for further processing according to whether the image is a front face view (corresponding, e.g., to a face tilt or head rotation of less than ˜5 degrees), or a side face view (corresponding, e.g., to a face tilt or head rotation of greater than ˜30 degrees). The front view face image may be expected to show little of the person's ears, while the side view face image may be expected to show more of the person's ear (either left ear or right ear).

An image (e.g., image 62) that is a front view face image (e.g., with a face tilt less than 5 degrees) may be processed at fiducial landmarks detection stage 140 through a first neural network model (e.g., CNN 15) to identify facial fiducial features or landmark points on the person's face (e.g., on the nose, chin, lips, forehead, eye pupils, etc.). The identified facial fiducial landmarks may include fiducial ear landmark points identified on the ears of the person. In example implementations, the fiducial ear landmarks may, for example, include left-ear and right-ear tragions (a tragion being an anthropometric point situated in the notch just above the tragus of each ear).

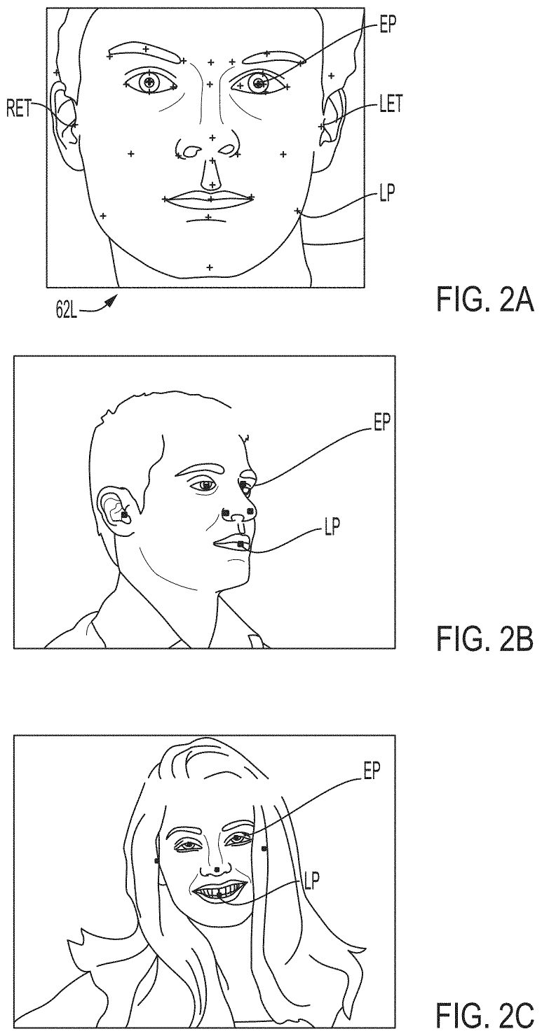

The processing of image 62 at fiducial landmarks detection stage 140 may mark image 62 with the identified facial fiducial landmarks to generate a marked image (e.g., image 62L, FIG. 2A) for output.

FIG. 2A shows an example marked image (e.g., image 62L) with two eye pupils EP and 36 facial landmark points LP marked on the image at fiducial landmarks detection stage 140 (e.g., by a Face-SSD model coupled to a face landmark model). The 36 facial landmark points LP can include landmark points on various facial features (e.g., brows, cheek, chin, lips, etc.) and include two anthropometric landmark tragion points (e.g., a left ear tragion (LET) and a right ear tragion (RET) marked on the left ear tragus and the right ear tragus of the person, respectively). In example implementations, a single landmark tragion point (e.g., the LET point for the left ear, or the RET point for the right ear) may be used as a geometrical reference point or fiducial marker to define a bounded portion or area (e.g., a rectangular area) of the image as an ear ROI area (e.g., ROI 64R) for the ear (left ear or the right ear) shown in the corresponding side view image (e.g., image 64).

In example implementations, of the identified fiducial landmarks (identified at fiducial landmarks detection stage 140) only the LET point or only the RET point may be used as a single geometrical reference point to identify the ear ROI area according to whether the 2-D side view face image shows a left ear or a right ear of the person.

In example implementations, the processing of image 62 at pose estimator stage 130, or at the fiducial landmarks detection stage 140 through the first neural network model (e.g., CNN 15), may include a determination of a parameter related to a size of the face of the person.

With renewed reference to FIG. 1, after fiducial landmarks detection stage 140, an image (e.g., image 64) segregated at pose estimator stage 130 as being a side view face image of the person's head (e.g., with a face tilt greater than 30 degrees) may be processed at an ear ROI extraction stage 150 through the first neural network model (e.g., CNN 15). CNN 15 may identify or mark a bounded geometrical portion or area of side view face image 64 as an ear ROI area (e.g., ROI 64R) for further processing through ESP detection stage 160. The geometrical size and location of the ear ROI area may be based, for example, on the co-ordinates of one or more of the facial fiducial landmarks identified at stage 140 on the marked image (e.g., image 62L) of the corresponding front view face image (e.g., image 62). The ear ROI area (e.g., ROI 64R) may show or include a portion or all of the person's ear.

In example implementations, at stage 150, the bounded geometrical portion or area of side view image 64 identifying the ear ROI area may be a rectangle disposed around or at a distance from a fiducial ear landmark (e.g., either a left-ear tragion or a right-ear tragion). The rectangular area may be extracted as an ear ROI area (e.g., ROI 64R) for further processing through ESP detection stage 160. In example implementations, the geometrical dimensions (e.g., width and height) of the bounded area defining the ear ROI may be dependent, for example, on a size of the face of the person (as may be determined, e.g., at stage 130, or at stage 140). In example implementations (e.g., with typical mobile phone image resolutions), the dimensions (e.g., width and height) of the bounded rectangular area may be less than about 1000×1000 pixels (e.g., 200×200 pixels, 128×96 pixels, 140×110 pixels, etc.)

At ESP detection stage 160, the ear ROI area (e.g., ear ROI 64R) may be further processed through a second trained convolutional neural network model (e.g., ESP-FCNN 16) to predict or identify an ESP location on the ear. ESP-FCNN 16 may, for example, predict or identify a location (e.g., location 64ES) in the ear ROI area (e.g., ROI 64R) as the person's ear saddle point. In example implementations, the location (e.g., location 64ES) may be defined as a pixel-sized location (or a few pixels-sized location) with 2-D co-ordinates (x, y) in an x-y plane of the 2-D image.

In example implementations, location 64ES may be used as the location of the person's ear saddle point when designing glasses for, or fitting glasses to, the person's head.

In example implementations of system 100, the convolutional neural network model (e.g., CNN 15) used at stages 120 to 150 in image processing pipeline 110 may be a pre-trained neural network model configured for detecting faces in images and for performing various face-related (classification/regression) tasks including, for example, pose estimates, smile recognition, face attribute prediction, pupil detection, fiducial marker detection, and Aruco marker detection, etc. In example implementations, CNN 15 may be a pre-trained single Shot Detection (SSD) model (e.g., Face-SSD). The SSD algorithm is called single shot because it predicts a bounding box (e.g., the rectangle defining the ear ROI) and a class of an image feature simultaneously as it processes the image in a same deep learning model. The Face-SSD model architecture may be summarized, for example, in the following steps:
1. A 300×300 pixels image is input into the architecture.
2. The input image is passed through multiple convolutional layers, obtaining different features at different scales.
3. For each feature map obtained in step 2, a 3×3 convolutional filter can be used to evaluate a small set of default bounding boxes.
4. For each default box evaluated, the bounding box offsets and class probabilities are predicted.

The Face-SSD used in image processing pipeline 110 can generate facial fiducial landmark points on an image (e.g., at stage 140).

In an example implementation, at fiducial landmarks detection stage 140, the Face-SSD model may provide access to 6 landmark points on a face image in addition to markers for the pupils of the eyes. FIG. 2B shows an example marked face image (e.g., a side view image) with two eye pupils EP and 4 facial landmark points LP marked on the image at fiducial landmarks detection stage 140 by the Face-SSD model. FIG. 2C shows another example marked face image (e.g., a front view image) with two eye pupils EP and 4 facial landmark points LP marked on the image at fiducial landmarks detection stage 140 by the Face-SSD model.

In example implementations, the marked face images with 4-6 facial landmarks processed by the Face-SSD model may be further processed by a face landmarker model which can generate additional landmarks (e.g., 36 landmarks, FIG. 2A) on the face images.

In example implementations of system 100, the Face-SSD model may be light weight in memory requirements (e.g., requiring only ˜1 MB memory), and may take less inference time compared to other models (e.g., a RetinaNet model) that can be used for extracting the ear ROIs. In example face recognition implementations (such as in image processing pipeline 110), the Face-SSD model can be executed to determine pose and a face size parameter related to the size of a face in an image. The identification of the left or the right ear tragion points (e.g., point LET or point RET), and further extracting an ear ROI by cropping a rectangle of fixed size around either of these tragion points) may not need any (substantial) additional computations by the Face-SSD model (other than the computations needed for running the Face-SSD model to determine the pose and the face size parameter of the face).

At ear ROI extraction stage 150, the two anthropometric tragion points LET and RET may be used as individual geometrical reference points to identify and extract (crop) ear ROIs from corresponding side view face images (e.g., image 64) for determining the left ear and right ear ESPs of the person. In example implementations, the ear ROIs may be rectangles of predefined (fixed) size (e.g., a width of “W” pixels and a height of “H” pixels). The ear ROI rectangles may be placed with a predefined orientation at a predefined distance d (in pixels) from the individual geometrical reference points. In example implementations, an ear ROI rectangle may enclose a tragion point (e.g., LET point or and RET point).

In example implementations, the predefined size of the rectangle cropping the ear ROI on the image (e.g., the width and height of the rectangle) may change based on the parameter related to the size of the face.

In some example implementations, other models (other than Face-SSD) may be used to mark facial landmark points as fiducial reference points for identifying and extracting the ear ROI areas around the ears in the images. Any model that predicts a landmark point on the face can be used to approximate and extract an ear ROI area around the ear. The predicted landmark point on the face (unlike the Face-SSD implementation discussed above with reference to FIGS. 2A-2C) need not be a point on the ear, but could be a landmark point anywhere on the face (e.g., a forehead, cheek, or brow landmark point). The predicted landmark point anywhere on the face may be used (e.g., as a fiducial reference point) to identify and extract the ear ROI from the side view face image (e.g., image 64).

In some example implementations of system 100, a simple machine learning (ML) model or a cross validation (CV) approach (e.g., a convolutional filter) may be used to further refine (if required) the ear ROI area derived using a single landmark point on the ear or on the face before image processing at stage 160 in image processing pipeline 110 to identify ESPs.

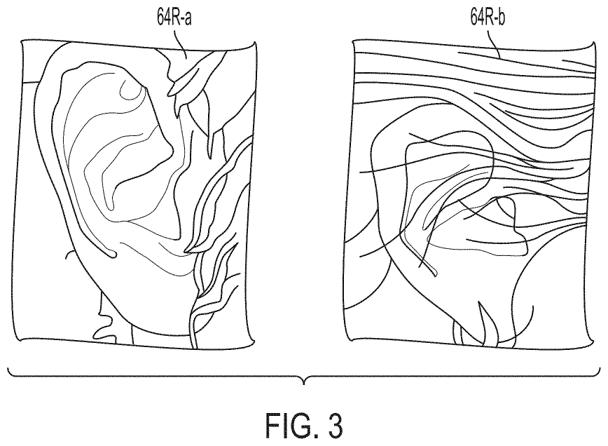

FIG. 3 shows examples of ear ROI areas (e.g., ear ROI 64R-a, ear ROI 64R-b) defined around the ears and extracted from side view face images (e.g., image 64) using just the single landmark point marked on each ear in the corresponding front view face image (e.g., image 62L), in accordance with the principles of the present disclosure.

In example implementations of system 100, the fully convolutional neural network model (e.g., ESP-FCNN 16) used at stage 160 in image processing pipeline 110 to identify ESPs may be a pre-trained neural network model configured to predict pixel-size ESP locations on the ear ROI areas extracted at stage 150. ESP-FCNN 16 can be a neural network model which is pre-trained to identify an ESP in an ear ROI area image by considering (i.e., processing) the entire image (i.e., all or almost all pixels of the ear ROI area image), one pixel at a time, to identify the pixel-size ESP. The one-pixel-at-a-time processing approach of ESP-FCNN 16 to identify the ESP within the ROI area image is in contrast to the processing approaches of other convolutional neural networks (CNN) (e.g., RetinaNet, Face-SSD, etc.) that may be, or have been used, to identify ESPs. These other CNN (e.g., RetinaNet, Face-SSD, can process the ear ROI area image only in patches (windows) of multiple pixels at a time, and result in classification of patch-size ESP.

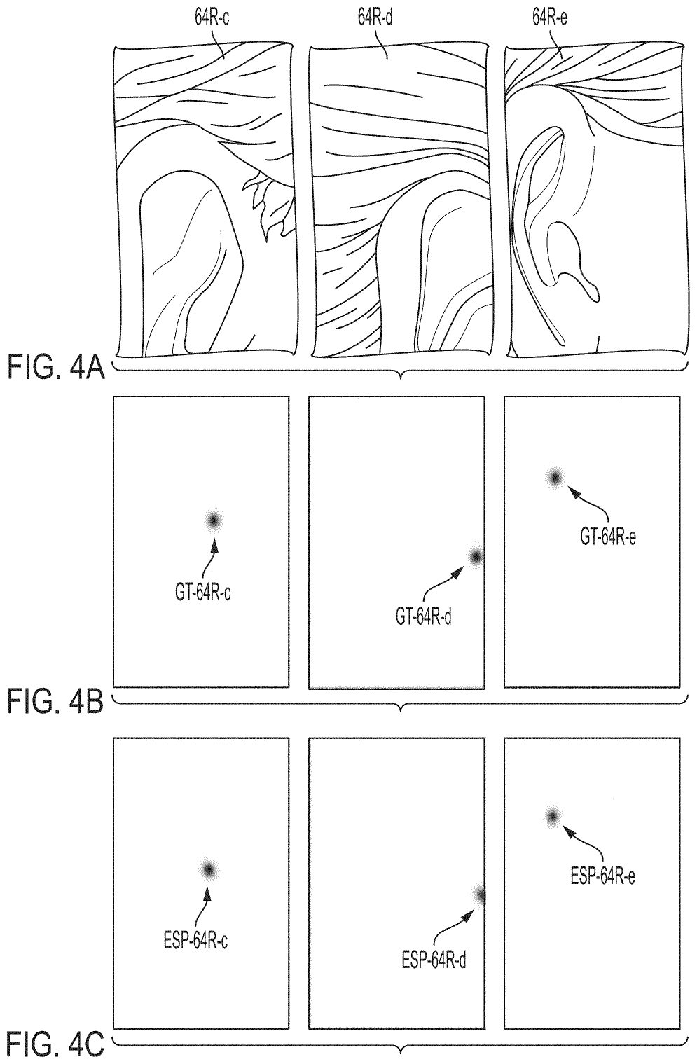

In example implementations, ESP-FCNN 16 may have an image segmentation architecture in which an image is divided into multiple segments, and every pixel in the image is associated with, or categorized (labelled) by, an object type. ESP-FCNN 16 may be configured to treat the identification of the ESPs as a segmentation problem instead of a classification problem (in other words, the identification of the ESPs may involve segmentation by pixels and giving a label to every pixel). An advantage of treating the identification of the ESPs as a segmentation problem is that method does not rely on fixed or precise ear ROI area crops and can run on a wide range of ear ROI area crops of varying quality and completeness (e.g., different lighting and camera angles, ears partially obscured or covered by hair, etc.). FIG. 3 (and FIG. 4A) shows, for example, a wide range of ear area crops of varying quality and completeness that may be processed through ESP-FCNN 16.

In example implementations, the trained neural network model (i.e., ESP-FCNN 16) generates predictions for the likelihood of each pixel in the ear ROI area image being the actual or correct ESP, in contrast to previous models which predict the likelihood that a whole patch or window of pixels in the image is the ESP. The model disclosed herein (i.e., ESP-FCNN 16) only leverages the image content in a receptive field instead of the whole input resolution, which relieves the dependency of ESP detection on the ear ROI area extraction model (i.e., CNN 15).

ESP-FCNN 16 may be configured to calculate features around each pixel only once and to reuse the calculated features to make predictions for nearby pixels. This configuration may enable ESP-FCNN 16 to reliably predict a correct ESP location even with a rough or imprecise definition of the ear ROI area (e.g., as defined by the Face-SSD model at stage 150). ESP-FCNN 16 may generate a probability or confidence value (e.g., a fractional integer value between 0 and 1) for each pixel being the actual or correct ESP location. ESP-FCNN 16 may generate, for the confidence value of a pixel, a floating point number that reflects an inverse distance of the pixel to the actual or correct ESP location. The floating point number may have a fractional integer value between zero and 1 (instead of a binary zero-or-one decision value whether or not the pixel is the correct ESP). ESP-FCNN 16 may be configured to generate a confidence map (prediction heatmap) in which pixels with high confidence prediction values are deemed to be the actual or correct ESP.

In example implementations, ESP-FCNN 16 may be, or include, a convolutional neural network (e.g., a U-Net model) configured for segmentation of the input images (i.e., the various ear ROI area images input for processing). The U-Net model may be a fully convolutional model with skip connections. In an example implementation, the model may include an encoder with three convolution layers having, for example, 8, 16, and 32 channels, and a decoder with four deconvolution layers having, for example, 64, 32, 16, and 8 channels. Skip connections may be added after each convolution. The model size may, for example, be small, for example, less than 1000 Kb (e.g., 246 Kb).

In another example implementation, the model may include an encoder with three convolution layers having, for example, 4, 8, 8 channels, and a decoder with four deconvolution layers having, for example, 16, 8, 8, and 4 channels. The model size may, for example, be smaller than 246 Kb.

In an example implementation, the U-Net model may be trained using augmentation techniques (e.g., histogram equalization, mean/std normalization, and cropping of random rectangular portions around the located landmark points, etc.) to make the model robust to variations in ear ROI area images input for processing. The trained U-Net model may take as input an ear ROI area image and predict a confidence map in the same resolution (pixel resolution) as the input image. In the confidence map, pixels with high confidence values may be designated or deemed to be the actual or correct ESP.

In an example implementation, the U-Net model is trained using only about 200 images of persons taken from only two different camera viewpoints (e.g., ˜90 degrees for front view face images, and ˜45 degrees for side view face (ear) images). The model generalizes well on different lighting and camera angles. FIG. 4A shows, for purposes of illustration, three example ear ROI area images (e.g., ear ROI 64R-c, ear ROI 64R-d. and ear ROI 64R-e) that can be used as training data for the U-Net model. The ear ROI area images in the training data may be annotated with the actual or ground truth (GT) ESP locations of the persons' ears in the images.

In example implementations, for training the U-Net model, the GT ESP locations may be defined, for example, by a Gaussian distribution function:

C=exp−(d²/(2*δ²),

where C is the confidence value, d is the distance to the GT ESP location, and δ is the standard deviation of the Gaussian distribution. A confidence in the model's ESP prediction will be higher for pixels closer to the GT ESP (and equal to 1 for the GT). A small value of the standard deviation δ in the definition of the GT may produce a largely blank confidence map, which can mislead the model in to generating a trivial result predicting zero confidence everywhere. Conversely, a large value of the standard deviation δ in the definition of the GT, may produce an overly diffuse confidence map, which can cause the model to fail to predict a precise location for the EPS. In example implementations, a value of standard deviation δ in the definition of the GT may be selected based on a desired precision in the predicted locations of the EPS. In example implementations, the value of standard deviation δ may be selected to be in a range of about 2 to 10 pixels (e.g., 3 pixels) as a satisfactory or acceptable precision required in the predicted locations of the EPS predicted by the U-Net model.

FIG. 4B schematically shows, for example, GT confidence maps for GT ESP locations (e.g., GT-64R-c, GT 64R-d, and GT 64R-e) for three example ear ROI area images (e.g., ear ROI 64R-c, ear ROI 64R-d. and ear ROI 64R-e) (FIG. 4A) that were used as training data for the U-Net model.

FIG. 4C schematically shows, for example, ESP confidence maps for ESP locations (e.g., ESP-64R-c, ESP-64R-d, and ESP-64R-e) predicted by the U-Net model for the three example ear ROI area images (e.g., ear ROI 64R-c, ear ROI 64R-d. and ear ROI 64R-e) (FIG. 4A).

A visual comparison of the GT and ESP confidence maps of FIG. 4B and FIG. 4C suggests that there can be a good match between the GT locations (e.g., GT-64R-c, GT-64R-d, and GT-64R-e) and the ESP locations (e.g., ESP-64R-c, ESP-64R-d, and ESP-64R-e) for the three example ear ROI area images (e.g., ear ROI 64R-c, ear ROI 64R-d. and ear ROI 64R-e) (FIG. 4A) used as training data for the U-Net model.

In example implementations, for training the U-Net model, comparison of the confidence maps of the GT locations and predicted ESP locations may involve evaluating perceptual loss functions (L2) and/or the least absolute error (L1) function.

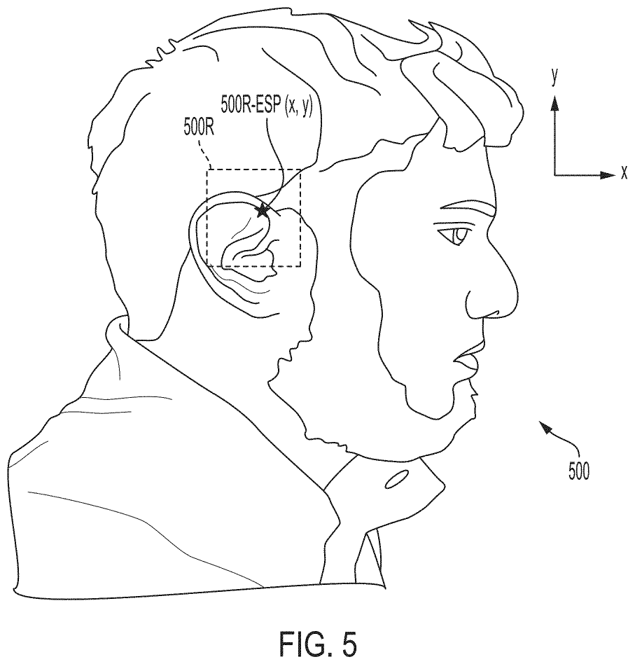

FIG. 5 shows, for purposes of illustration, an example side view face image 500 of a person processed by system 100 through image processing pipeline 110 to identify a 2-D ESP on a side of the person's right ear. As shown in FIG. 5, system 100 (e.g., at stage 150, FIG. 1) may mark or identify a rectangular portion (e.g., 500R) of image 500 as the ear ROI area. System 100 may process the ear ROI area image (e.g., ear ROI 500R) through ESP-FCNN 16 (e.g., at stage 160, FIG. 1), as discussed above, to yield a predicted 2-D ESP (e.g., 500R-ESP) location in the x-y plane of image 500. In FIG. 5, the predicted 2-D ESP (e.g., 500R-ESP), which may have two-dimensional co-ordinates (x, y), is shown as being overlaid on the 2-D image of the person's ear.

Virtual fitting technology can let users try on pairs of virtual glasses from a computer. The technology may measure a user's face by homing in on pupils, ears, cheekbones, ears and other facial landmarks, and then come back with images of one or more different pairs of glasses that might be a good fit.

With renewed reference to FIG. 1, the predicted 2-D ESP (e.g., 500R-ESP) may be further projected through three dimension space to a 3-D ESP point in a computer-based system (e.g., a virtual-try-on (VTO) system 600) for virtually fitting glasses to the person.

System 600 may include a processor 17, a memory 18, a display 19, and a 3-D head model 610 of the person. 3-D head model 610 of the person's head may include 3-D representations or depictions of the person's facial features (e.g., eyes, ears, nose, etc.). The 3-D head model may be used, for example, as a mannequin or dummy, for fitting glasses to the person in VTO sessions. System 600 may be included in, or coupled to, system 100.

System 600 may receive 2-D coordinates (e.g. (x, y)) of the predicted 2-D ESP (e.g., 500R-ESP, FIG. 5) for the person, for example, from system 100. In system 600, processor 17 may execute instructions (stored, e.g., in memory 18) to snap the predicted 2-D ESP having two-dimensional co-ordinates (x, y) on to the model of the person's ear (e.g., to a lobe of the ear), and project it by ray projection through 3-D space to a 3-D ESP point (x, y, z) on a side of the person's ear. A depth search may be carried out in a predefined cuboid region of the 3-D head model to find a depth point (e.g., co-ordinate z) for locating a projected 3-D ESP point on the 3-D head model 610 at the depth z behind or to a side of the person's ear. The (x, y) coordinates of the projected 3-D ESP point may be the same as the (x, y) coordinates of the 2-D ESP point. However, the z coordinate of the projected 3-D ESP point may be set to be the z coordinate of the deepest point found in the depth search of the cuboid region. System 600 may then generate virtual glasses to fit the 3-D head model with temple pieces of the glasses resting on, or passing through, the projected 3-D ESP point for a good fit.

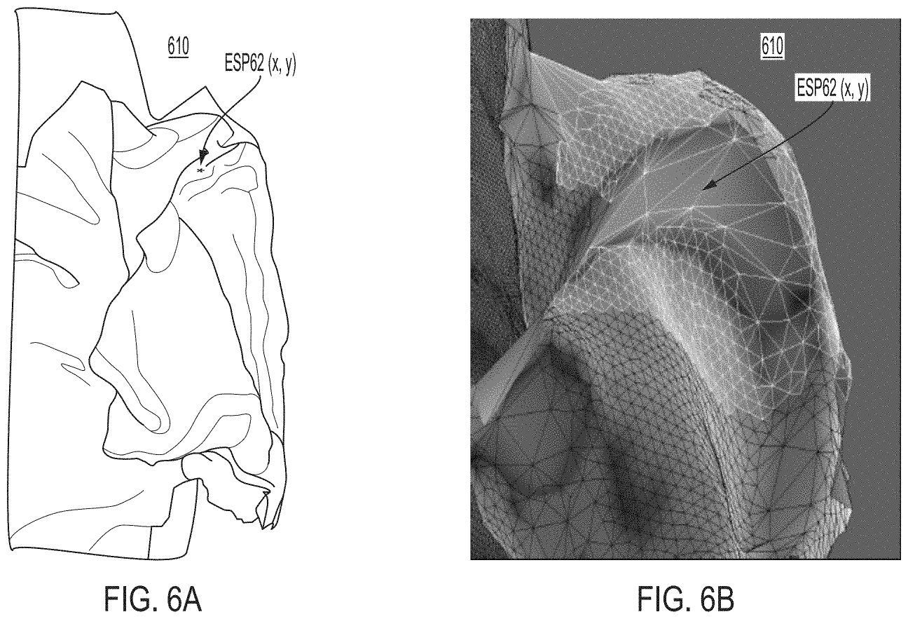

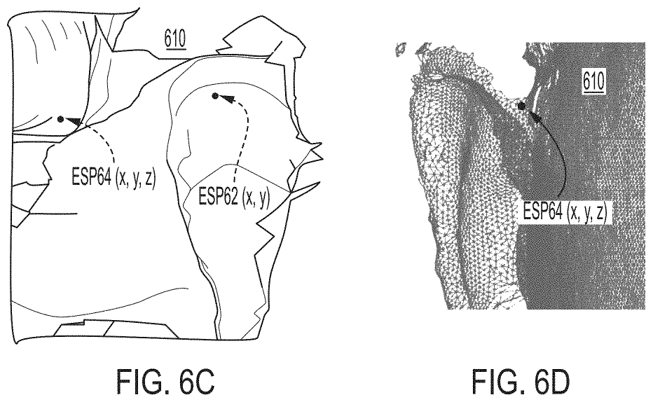

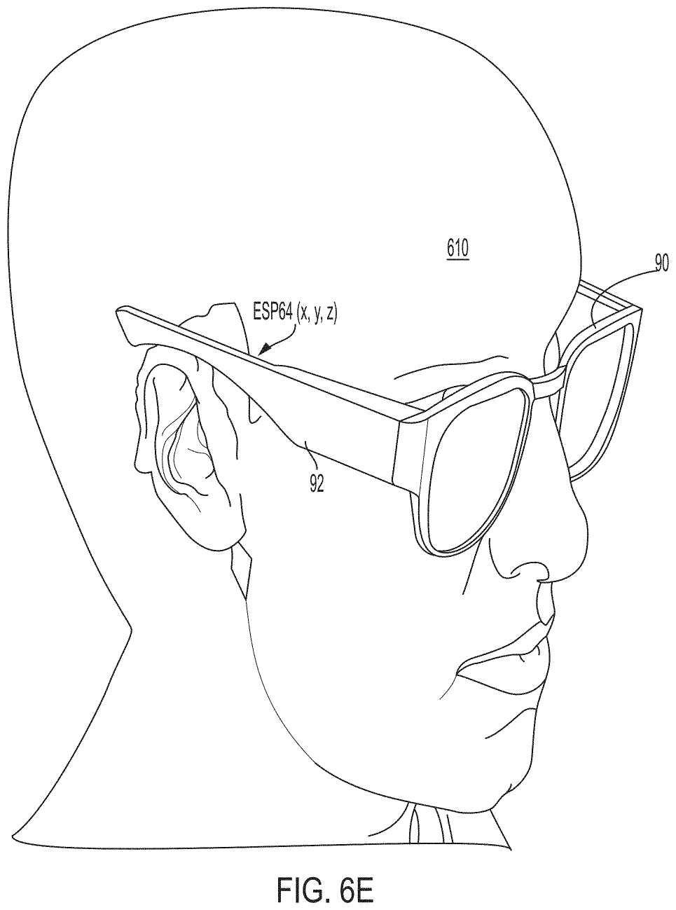

FIG. 6A shows, for example, a portion of 3-D head model 610 of a person processed by system 600 with an original predicted 2-D ESP (e.g., ESP 62 (x, y)) snapped on an outer lobe of the person's ear.

FIG. 6B illustrates cuboid regions (i.e., convex polyhedrons) of 3-D head model 610 that may be searched by system 600 to find a depth point for locating a projected 3-D ESP point (e.g., ESP 64 (x, y, z), FIG. 6C) at a depth z behind, or to a side of, the person's ear.

FIG. 6C shows, for example, the portion of 3-D head model 610 including the person's ear with the original predicted 2-D ESP (e.g., ESP 62 (x, y)) snapped on an outer lobe of the person's ear, and the projected 3-D ESP point (e.g., ESP 64 (x, y, z),) disposed at a depth z behind, or to a side of, the person's ear.

FIG. 6D illustrates another view of 3-D head model 610 with the projected 3-D ESP point (e.g., ESP 64 (x, y, z)) disposed at a depth z behind, and to a side of, the person's ear.

FIG. 6E illustrates the example 3-D head model 610 fitted with a pair of virtual glasses (e.g., glasses 90) having a temple piece (e.g., temple piece 92) passing through or attached to the projected 3-D ESP point (e.g., ESP 64 (x, y, z)) in 3-D space.

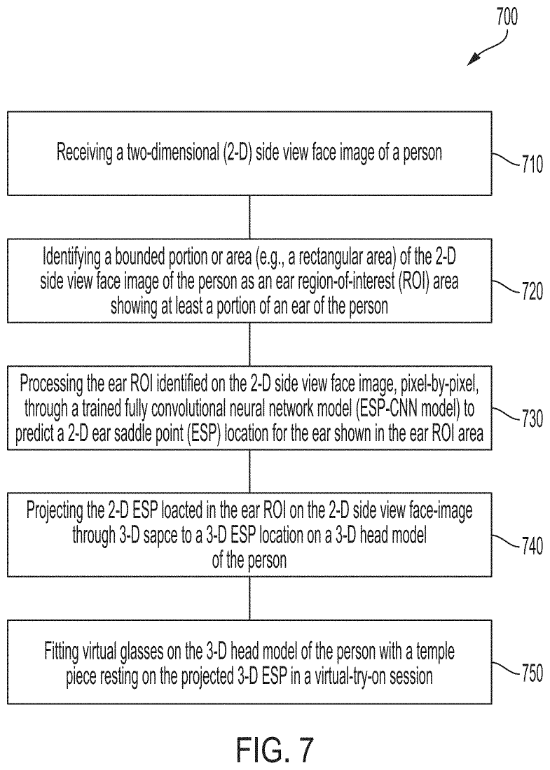

FIG. 7 illustrates an example method 700 for determining 2-D locations of ear saddle points (ESP) of a person from 2-D images of the person's face, in accordance with the principles of the present disclosure. Method 700 may be implemented, for example, in system 100. In example scenarios, method 700 (and at least some portions of system 100) may be implemented on a mobile phone.

Method 700 includes receiving a two-dimensional (2-D) side view face image of the person (710), and identifying a bounded portion or area (e.g., a rectangular area) of the 2-D side view face image of the person as an ear region-of-interest (ROI) area (720). The ear ROI area may show at least a portion of an ear (e.g., a left ear or a right ear) of the person.

Method 700 further includes processing the ear ROI area identified on the 2-D side view face image, pixel-by-pixel, through a trained fully convolutional neural network model (ESP-CNN model) to predict a 2-D ear saddle point (ESP) location for the ear shown in the ear ROI area (730).

In method 700, identifying the ear ROI area on the 2-D side view face image 720 may include receiving a 2-D front view face image of the person corresponding to the 2-D side view face image of the person (received at 710), and processing the 2-D front view face image through a trained fully convolutional neural network model (e.g., a Face-SSD model) to identify the ear ROI area. A shape (e.g., a rectangular shape) and a pixel-size of the bounded area of the ear ROIs may be predefined. In example implementations, the pixel-size of the ear ROI area may be less than about 1000×1000 pixels (e.g., 200×200 pixels, 128×96 pixels, 140×110 pixels, etc.). In example implementations, the size of the bounded area of the ear ROIs may be based on a face size parameter related to the size of the face shown, for example, in the front view face image of the person.

In example implementations, the Face-SSD model may identify one or more facial landmark points on the 2-D front view face image. The identified facial landmark points may for example, include a left ear tragion (LET) point and a right ear tragion (RET) point (disposed on the left ear tragus and the right ear tragus of the person, respectively). The Face-SSD model may define a portion or area of the 2-D side view face image as being bounded, for example, by a rectangle. The position of the bounding rectangle may be determined using one or more of the identified facial landmark points as geometrical fiducial reference points.

After the ear ROI area is identified (at 720) in method 700, processing the ear ROI area, pixel-by-pixel, through the trained ESP-CNN model 730 may include image segmentation of the ear ROI area and using each pixel for category prediction. The trained ESP-CNN model may, for example, predict a probability or confidence value for each pixel in the ear ROI area that the pixel is an actual or correct 2-D ESP location. The predicted confidence value for a pixel may be a floating point number reflecting an inverse distance from the pixel to the actual or correct ESP location (instead of a binary decision whether or not the pixel is the correct 2-D ESP). In example implementations, processing the ear ROI area, pixel-by-pixel, through the trained ESP-CNN model 730 may be include generating a confidence map (prediction heatmap) in which pixels with high confidence are predicted to be the correct 2-D ESP.

In example implementations of method 700, when the identified ear ROI area may have a size less than 1000×1000 pixels, the trained ESP-CNN model (e.g., a U-Net) may have a size less than 1000 Kb (e.g., 246 Kb).

Method 700 may further include projecting the predicted 2-D ESP located in the ear ROI area on the 2-D side view face image through 3-D space to a 3-D ESP location on a 3-D head model of the person (740), and fitting virtual glasses to the 3-D head model of the person with a temple piece of the glasses resting on the projected 3-D ESP in a virtual-try-on-session (750).

Method 700 may further include making hardware for physical glasses fitted to the person, corresponding, for example, to the virtual glasses fitted to the 3-D head model in the virtual-try-on-session. The physical glasses (intended to be worn by the person) may include a temple piece fitted to rest on an ear saddle point of the person corresponding to the projected 3-D ESP.

Virtual try-on technology can let users try on trial pairs of glasses, for example, on a virtual mirror in a computer display, before deciding which pair of glasses look or feel right. As an example a user can, for example, upload self-images (a single image, a bundle of pictures, a video clip or a real-time camera stream) to a virtual try-on (VTO) system (e.g., system 600). The VTO system may generate real-time realistic-looking images of a trial pair of virtual glasses positioned on the user's face. The VTO system may render images of the user's face with the trial pair of virtual glasses, for example, in a real-time sequence (e.g., in a video sequence) of image frames that the user can see on the computer display as she turns or tilts her head from side to side.

For proper positioning or fitting of the trial pair of virtual glasses, the VTO system may use face detection algorithms or convolutional networks (e.g., Retinanet, Face-SSD, etc.) to detect the user's face and identify facial features or landmarks (e.g., pupils, ears, cheekbones, nose, and other facial landmarks) in each image frame. The VTO system may use one or more facial landmarks as key points for positioning the trial pair of virtual glasses in an initial image frame, and track the key points across the different image frames (subsequent to the initial image frame shown to the user) using, for example, a simultaneous localization and mapping (SLAM) algorithm.

Conventional VTO systems may not use ESPs to determine where the temple pieces of the trial pair of virtual glasses will sit on the ears in each image frame. Without such determination, the trial pair virtual glasses may appear to float around (e.g., up or down from the ears) from image frame-to-image frame across the different image frames (especially in profile or side views) shown to the user, and result in a poor virtual try-on experience.

The VTO solutions described herein involve determining ESP locations (e.g., ESP 62 (x, y), FIG. 6A) in at least one image frame, and using the determined ESP locations for positioning temple pieces of the pair of virtual glasses on the user's face in a sequence of image frames, in accordance with the principles of the present disclosure.

In example implementations, any face recognition technology or methods, (e.g., RetinaNet, Face-SSD, or system 100 and method 700 discussed above) may be used to determine 2-D ESP locations (e.g., ESP 62 (x, y), FIG. 6A) on the user's face in an image frame.

In an example VTO solution, the 2-D ESP locations may be determined for a left ear and a right ear in respective image frames showing the left ear or the right ear. ESP locations that are determined with confidence values greater than a threshold value (e.g., with confidence values >0.8, or with confidence values >0.7) as being the correct ESP locations may be referred to herein as “robust ESPs.” The robust ESPs may be designated to be, or used as, key points for positioning temple pieces of the pair of virtual glasses in the respective image frames showing the left ear or the right ear. The VTO system may further track the key points across the different image frames (subsequent to the initial respective image frames) using, for example, SLAM/key point tracking technology, to keep the temple pieces of the trial pair of virtual glasses locked onto the robust ESPs in the different image frames. The temple pieces of the trial pair of virtual glasses may be locked onto the robust ESPs/key points regardless of the different perspectives (i.e., side views) of the user's face in the different image frames.

The foregoing example VTO solution avoids a need to determine ESPs anew for every image frame, and avoids possible jitter in the VTO display that can result if new ESPs or no ESPs are used on each image frame for placement of the temple pieces of the pair of virtual glasses.

In an example implementations, ESPs may be determined on one or more image frames to identify ESPs having sufficiently high confidence values (e.g., confidence values >0.8, or >0.7) to be used as robust ESPs/key points for positioning the temple pieces of the pair of virtual glasses in subsequent image frames (e.g., with SLAM/key point tracking technology).

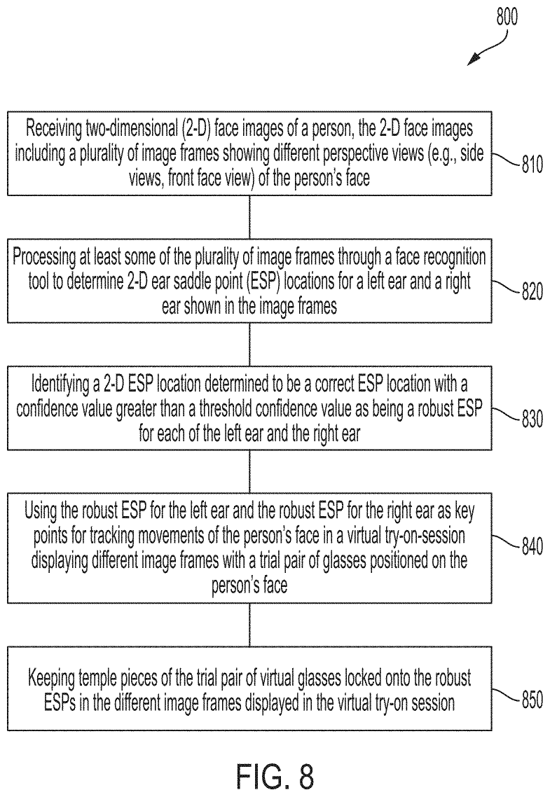

FIG. 8 illustrates an example method 800 for determining and using 2-D locations of ear saddle points (ESPs) as robust ESPs/key points in a virtual try-on session, in accordance with the principles of the present disclosure. Method 800 may be implemented, for example, in system 600.

Method 800 includes receiving two-dimensional (2-D) face images of a person (810). The 2-D face images may, for example, include a series of single images, a bundle of pictures, a video clip or a real-time camera stream. The 2-D face images may include a plurality of image frames showing different perspective views (e.g., side views, front face views) of the person's face.

Method 800 further includes processing at least some of the plurality of image frames through a face recognition tool to determine 2-D ear saddle point (ESP) locations for a left ear and a right ear shown in the image frames (820). In example implementations, the face recognition tool may be a convolutional neural network (e.g., Face-SSD, ESP-CNN, etc.).

Method 800 further includes identifying a 2-D ESP location determined to be a correct ESP location with a confidence value greater than a threshold confidence value as being a robust ESP for each of the left ear and the right ear (830). The threshold confidence value for identifying the determined ESP as being the robust ESP may, for example, be in a range 0.6 to 0.9 (e.g., 0.8).

Method 800 further includes using the robust ESP for the left ear and the robust ESP for the right ear as key points for tracking movements of the person's face in a virtual try-on session displaying different image frames with a trial pair of glasses positioned on the person's face (840).

Method 800 further includes keeping temple pieces of the trial pair of virtual glasses locked onto the robust ESPs in the different image frames displayed in the virtual try-on session (850).

An example snippet of logic code that may be used in system 600 and method 800 to find robust ESPs for a person's left ear and right ear in the 2-D images of the person is shown below:

### Example Logic

esp_min_threshold=0.6; // anything below this is not useful
esp_max_threshold=0.8; // if we've hit this, no need to run ESP for that ear anymore
min_threshold_update=0.02; // don't update unless we get at least this much improvement
current_left_esp_conf=0;
current_right_esp_conf=0;
Run face detection;
if (current_left_esp_conf<esp_max_threshold∥current_right_esp_conf<esp_max_threshold) {Determine which ear is primarily visible based on pose of face;
Run ear saddle point detection for that ear;
if (new_esp_conf>esp_min_threshold && new_esp_conf>current_XXXX_esp_conf+min_threshold_update) {
current_XXXX_esp_conf=new_esp_conf;

(Update key points to track new point using areas of the face which are more fixed such as the nose, brow, ears)

if (ESP wasn't updated this frame) {
Use ESP and key points from previous frame to update ESP for current frame;}

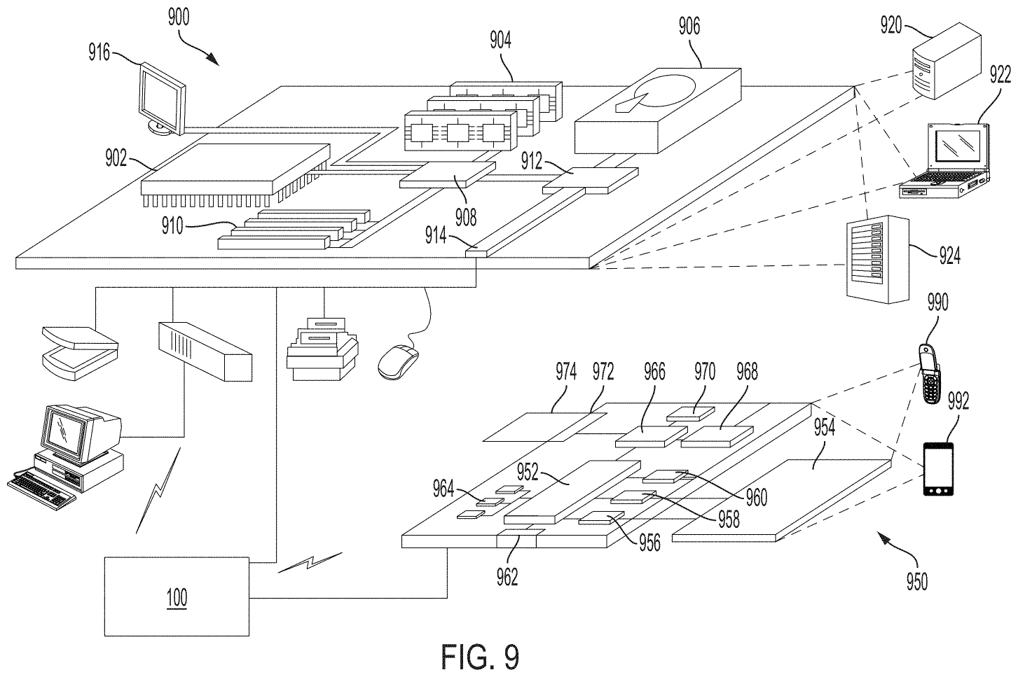

FIG. 9 shows an example of a computing device 900 and a mobile computer device 950, which may be used with image processing system 100 (and consumer electronic devices such as smart phones that may incorporate components of image processing system 100), and with the techniques described here. Computing device 900 is intended to represent various forms of digital computers, such as laptops, desktops, workstations, personal digital assistants, servers, blade servers, mainframes, and other appropriate computers. Computing device 950 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 900 includes a processor 902, memory 904, a storage device 906, a high-speed interface 908 connecting to memory 904 and high-speed expansion ports 910, and a low-speed interface 912 connecting to low-speed bus 914 and storage device 906. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high-speed interface 908. In some implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In some implementations, the memory 904 is a volatile memory unit or units. In some implementations, the memory 904 is a non-volatile memory unit or units. The memory 904 may also be another form of computer-readable medium, such as a magnetic or optical disk.

The storage device 906 is capable of providing mass storage for the computing device 900. In some implementations, the storage device 906 may be or contain a computer-readable medium, such as a floppy disk device, a hard disk device, an optical disk device, or a tape device, a flash memory or other similar solid-state memory device, or an array of devices, including devices in a storage area network or other configurations. The computer program product can be tangibly embodied in an information carrier. The computer program product may also contain instructions that, when executed, perform one or more methods, such as those described above. The information carrier is a computer- or machine-readable medium, such as the memory 904, the storage device 906, or memory on processor 902.

The high-speed controller 908 manages bandwidth-intensive operations for the computing device 900, while the low-speed controller 912 manages lower bandwidth-intensive operations. Such allocation of functions is exemplary only. In some implementations, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 952, 954, 964, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 856 may comprise appropriate circuitry for driving the display 954 to present graphical and other information to a user. The control interface 958 may receive commands from a user and convert them for submission to the processor 952. In addition, an external interface 962 may be provide in communication with processor 952, to enable near area communication of device 950 with other devices. External interface 962 may provide, for example, for wired communication in some implementations, or for wireless communication in some implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 974 may also be provided and connected to device 950 through expansion interface 972, which may include, for example, a SIMM (Single In Line Memory Module) card interface. Such expansion memory 974 may provide extra storage space for device 950, or may also store applications or other information for device 950. Specifically, expansion memory 974 may include instructions to carry out or supplement the processes described above, and may include secure information also. Thus, for example, expansion memory 974 may be provide as a security module for device 950, and may be programmed with instructions that permit secure use of device 950. In addition, secure applications may be provided via the SIMM cards, along with additional information, such as placing identifying information on the SIMM card in a non-hackable manner.

The memory may include, for example, flash memory and/or NVRAM memory, as discussed below. In some implementations, a computer program product is tangibly embodied in an information carrier. The computer program product contains instructions that, when executed, perform one or more methods, such as those described above. The information carrier is a computer- or machine-readable medium, such as the memory 964, expansion memory 974, or memory on processor 952, that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, Wi-Fi, or other such transceiver (not shown). In addition, GPS (Global Positioning System) receiver module 970 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 990. It may also be implemented as part of a smart phone 99892, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation In some or more computer programs that are executable and/or interpretable on a programmable system including at least one programmable processor, which may be special or general purpose, coupled to receive data and instructions from, and to transmit data and instructions to, a storage system, at least one input device, and at least one output device. Various implementations of the systems and techniques described here can be realized as and/or generally be referred to herein as a circuit, a module, a block, or a system that can combine software and hardware aspects. For example, a module may include the functions/acts/computer program instructions executing on a processor (e.g., a processor formed on a silicon substrate, a GaAs substrate, and the like) or some other programmable data processing apparatus.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations s only and is not intended to be limiting of example implementations. As used herein, the singular forms a, an, and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device or mobile electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

1. An image processing system, comprising:
a processor;
a memory; and
a fully convolutional neural network (FCNN) model, the FCNN model being trained to process, pixel-by-pixel, an ear region-of-interest (101) area of a two-dimensional (2-D) side view face image of a person to predict a 2-D ear saddle point (ESP) location on the 2-D side view face image, the ear ROI area showing at least a portion of the person's ear,
the processor being configured to execute instructions stored in memory to:
receive the 2-D side view face image of the person; and
process the ear ROI area of the 2-D side view face image, pixel-by-pixel, through the FCNN model to locate the 2-D ESP.

2. The image processing system of claim 1, wherein the ear ROI area is less than 200×200 pixels in size.

3. The image processing system of claim 1, wherein the FCNN model is less than 1000 Kb in size.

4. The image processing system of claim 1, wherein the FCNN model has an image segmentation architecture.

5. The image processing system of claim 1, wherein the FCNN model predicts a confidence value for each pixel in the ear ROI area being the ESP location, and the processor is configured to execute instructions stored in memory to generate a confidence map in which pixels are deemed to be the ESP based on their confidence values.

6. The image processing system of claim 5, wherein the FCNN model, for the confidence value of each pixel, generates a floating point number that reflects an inverse distance of the pixel to a correct ESP location.

7. The image processing system of claim 1, wherein the FCNN model is a first CNN model, and wherein the system includes a second convolutional neural network model (second CNN model) configured to identify the ear ROI area of the 2-D side view face image of the person.

8. The image processing system of claim 7, wherein the second CNN model is configured to identify fiducial landmark points on a front view face image of the person and to use at least one of fiducial landmark points as a geometrical reference point to identify the ear ROI area of the 2-D side view face image of the person.

9. The image processing system of claim 8, wherein the fiducial landmark points identified on the front view face image include a left ear tragion (LET) point and a right ear tragion (RET) point marked on a left ear tragus and a right ear tragus, respectively, and wherein only the LET point or only the RET point is used for a geometrical reference point to identify the ear ROI area according to whether the 2-D side view face image shows a left ear or a right ear of the person.

10. The image processing system of claim 7, wherein the second CNN model is a pre-trained Single Shot Detection (SSD) model.

11. The image processing system of claim 10, wherein the second CNN model is less than 1000 Kb in size.

12. The image processing system of claim 1, wherein the processor is configured to execute instructions stored in memory to project the predicted 2-D ESP location on the 2-D side view face image through 3-dimensional (3D) space to a 3-D ESP location on a 3-D head model of the person.

13-25. (canceled)

26. A computer-implemented method, comprising:
receiving a two-dimensional (2-D) side view face image of a person; and
processing an ear region of interest (ROI) area of the 2-D side view face image, pixel-by-pixel, through a fully convolutional neural network (FCNN) model to locate a 2-D ear saddle point (ESP), the FCNN model being trained to process, pixel-by-pixel, the ear RI area of the 2-D side view face image of the person to predict the 2-D ESP location on the 2-D side view face image, the ear ROI area showing at least a portion of the person's ear.

27. The computer-implemented method of claim 26, wherein the ear ROI area is less than 200×200 pixels in size, and wherein the FCNN model is less than 1000 Kb in size and has an image segmentation architecture.

28. The computer-implemented method of claim 26, wherein the FCNN model predicts a confidence value for each pixel in the ear ROI area being the ESP location, and the method further includes generating a confidence map in which pixels are deemed to be the ESP based on their confidence values, and wherein the FCNN model, for the confidence value of each pixel, generates a floating point number that reflects an inverse distance of the pixel to a correct ESP location.

29. The computer-implemented method of claim 26, wherein the FCNN model is a first CNN model, and wherein the computer-implemented method further utilizes a second convolutional neural network model (second CNN model) to identify the ear ROI area of the 2-D side view face image of the person, and wherein the second CNN model is configured to identify fiducial landmark points on a front view face image of the person and to use at least one of fiducial landmark points as a geometrical reference point to identify the ear ROI area of the 2-D side view face image of the person.

30. The computer-implemented method of claim 29, wherein the fiducial landmark points identified on the front view face image include a left ear tragion (LET) point and a right ear tragion (RET) point marked on a left ear tragus and a right ear tragus, respectively, and wherein only the LET point or only the RET point is used for a geometrical reference point to identify the ear ROI area according to whether the 2-D side view face image shows a left ear or a right ear of the person.

31. The computer-implemented method of claim 29 wherein the second CNN model is a pre-trained Single Shot Detection (SSD) model, and wherein the second CNN model is less than 1000 Kb in size.

32. The computer-implemented method of claim 26, further comprising projecting the predicted 2-D ESP location on the 2-D side view face image through 3-dimensional (3D) space to a 3-D ESP location on a 3-D head model of the person.

33. A non-transitory computer-readable medium storing executable instructions that when executed by at least one processor are configured to cause the at least one processor to:
receive a two-dimensional (2-D) side view face image of a person; and
process an ear region of interest (ROI) area of the 2-D side view face image, pixel-by-pixel, through a fully convolutional neural network (FCNN) model to locate a 2-D ear saddle point (ESP), the FCNN model being trained to process, pixel-by-pixel, the ear ROI area of the 2-D side view face image of the person to predict the 2-D ESP location on the 2-D side view face image, the ear ROI area showing at least a portion of the person's ear.

34. The non-transitory computer-readable medium of claim 33, wherein the ear ROI area is less than 200×200 pixels in size, and Wherein the FCNN model is less than 1000 Kb in size and has an image segmentation architecture.

35. The non-transitory computer-readable medium of claim 33, wherein the FCNN model predicts a confidence value for each pixel in the ear ROI area being the ESP location, and the instructions when executed further generate a confidence map in which pixels are deemed to be the ESP based on their confidence values, and wherein the FCNN model, for the confidence value of each pixel, generates a floating point number that reflects an inverse distance of the pixel to a correct ESP location.

36. The non-transitory computer-readable medium of claim 33, wherein the FCNN model is a first CNN model, and wherein the instructions when executed further utilize a second convolutional neural network model (second CNN model) to identify the ear ROI area of the 2-D side view face image of the person, and wherein the second CNN model is configured to identify fiducial landmark points on a front view face image of the person and to use at least one of fiducial landmark points as a geometrical reference point to identify the ear ROI area of the 2-D side view face image of the person, and wherein the second CNN model is a pre-trained Single Shot Detection (SSD) model and is less than 1000 Kb in size.

37. The non-transitory computer-readable medium of claim 36, wherein the fiducial landmark points identified on the front view face image include a left ear tragion (LET) point and a right ear tragion (RET) point marked on a left ear tragus and a right ear tragus, respectively, and wherein only the LET point or only the RET point is used for a geometrical reference point to identify the ear ROI area according to whether the 2-D side view face image shows a left ear or a right ear of the person.

38. The non-transitory computer-readable medium of claim 33, wherein the instructions when executed by the at least one processor cause the at least one processor to further project the predicted 2-D ESP location on the 2-D side view face image through 3-dimensional (3D) space to a 3-D ESP location on a 3-D head model of the person.
